(19) United States
(12) Patent Application Publication
(10) Pub. No.: US 2002/0146951 A1
(43) Pub. Date: Oct. 10, 2002

(54) Staple fiber for electret non-woven fabric, process for the production of the electret non-woven fabric, and article to which the electret non-woven fabric is applied

(76) Inventors: J.C. Tai, Tainan District (TW); Yen Jung Hu, Shin Zhu (TW); Yee-Chun Chen, Tainan District (TW); Atsushi Kajita, Kooriyama-shi (JP); Shigeki Hayashi, Kooriyama-shi (JP)

Correspondence Address: NIXON & VANDERHYE, P.C., 8th Floor, 1100 North Glebe Road, Arlington, VA, 22201-4714, US

(21) Appl. No.: 10/062,568

(22) Filed: Feb. 5, 2002

(30) Foreign Application Priority Data
Feb. 8, 2001 (JP) 2001-32101

(51) Int. Cl. B32B 5/02; D04H 1/00; B32B 27/04

(52) U.S. Cl. 442/100; 428/359; 428/361; 428/373; 428/375; 442/84

(57) ABSTRACT

A staple fiber for an electret non-woven fabric, which is a polyolefin heat-bonding fiber having 0.05 to 1.0% by weight of an oil adhering thereto, characterized in that the amount of the adhering oil decreases to 0.001 to 0.2% by weight, and that the decrease ratio of the amount of the adhering oil can be at least 60%, under heat treatment for forming the polyolefin heat-bonding fiber into a non-woven fabric and/or under heat treatment of a non-woven fabric formed of the polyolefin heat-bonding fiber.

### FIELD OF THE INVENTION

The present invention relates to a staple fiber for an electret non-woven fabric, a process for the production of an electret non-woven fabric, and articles to which the electret non-woven fabric is applied, such as a filter material and a filter device.

### PRIOR ART OF THE INVENTION

The main purpose in electrically charging a non-woven fabric is to improve the filtration efficiency of a filter material or a filter device made of such a non-woven fabric.

As an electret non-woven fabric, there is known a product prepared by electrically charging a melt-blown non-woven fabric obtained according to a melt-blow method. However, there is not yet available any electret non-woven fabric that is made from a staple fiber as a raw material. That is because oil adheres to the surface of a staple fiber since it is required to apply an oil when the staple fiber is produced. The oil has hydrophilic properties and electric conductivity and therefore releases all the electrostatic charge from the fiber surface, so that it is impossible to directly treat the fiber for electric charging. It is therefore general practice to remove the oil beforehand and dry the fiber before the electric-charging treatment, which requires a complicated step and increases a cost.

### SUMMARY OF THE INVENTION

It is a first object of the present invention to provide a staple fiber for an electret non-woven fabric, which staple fiber has advantages that (a) the staple fiber can give a non-woven fabric that can be directly electrically charged without removing an oil, and that (b) the staple fiber can give, by electric-charging treatment, an electret non-woven fabric that can maintain excellent electret performances for a long period of time.

It is a second object of the present invention to provide a method for the production of an electret non-woven fabric from the staple fiber that achieves the first object of the present invention.

Further, it is a third object of the present invention to provide an article (such as a filter material or a filter device) produced from the non-woven fabric obtained by the production method that achieves the second object of the present invention.

For achieving the above objects, the present inventors have made diligent studies and as a result have found that the above objects are achieved by a polyolefin heat-bonding fiber which has a specific amount of an oil adhering thereto, and which has the above adhering oil decreased to a specific range and shows an oil decrease ratio greater than a certain value when heat-treated for forming it into a non-woven fabric or when a non-woven fabric formed therefrom is heat-treated, and the present invention has been completed on the basis of the above finding.

That is, according to the present invention, there are provided:

(1) a staple fiber for an electret non-woven fabric, which is a polyolefin heat-bonding fiber having 0.05 to 1.0% by weight of an oil adhering thereto, characterized in that the amount of the adhering oil decreases to 0.001 to 0.2% by weight, and that the decrease ratio of the amount of the adhering oil, represented by the equation (I), can be at least 60%,

Decrease ratio (%) of the amount of the adhering oil=[(A−B)/A]×100 (I)

wherein A is an amount (% by weight) of the oil adhering to the heat-bonding fiber and B is an amount of the oil adhering to the non-woven fabric after the heat treatment,

under heat treatment for forming the polyolefin heat-bonding fiber into a non-woven fabric and/or under heat treatment of a non-woven fabric formed of the polyolefin heat-bonding fiber,

(2) a process for the production of an electret non-woven fabric, which comprises;

the first step of providing, as a raw material, a staple fiber to which an oil containing, as a main component, an ester obtained from a polyethylene glycol having a molecular weight of 400 to 800 and a fatty acid having 10 to 20 carbon atoms is applied, and opening and carding said staple fiber, to obtain a web,

the second step of binding the web to obtain a non-woven fabric,

the third step of heat-treating the non-woven fabric, and

the fourth step of electrically charging the heat-treated non-woven fabric, to obtain an electret non-woven fabric, and

(3) an article obtained from an electret non-woven fabric obtained by the process described in the above (2).

### BRIEF DESCRIPTION OF DRAWINGS

FIG. 1 is a flow chart of the process for the production of an electret non-woven fabric.

### PREFERRED EMBODIMENTS OF THE INVENTION

The staple fiber for an electret non-woven fabric, provided by the present invention, comprises a polyolefin heat-bonding fiber and an oil adhering to the fiber. The polyolefin heat-bonding fiber is a sheath-core type or double aligned type polyolefin composite fiber containing a low-melting component selected from a high-density polyethylene, a low-density polyethylene, a linear low-density polyethylene, an ethylene-propylene random copolymer or an ethylene-vinyl acetate copolymer (EVA), and a high-melting component selected from a polypropylene, a polyester (PET, PBT or PPT) or polyamide (nylon 6 or nylon 66). While it is preferred to use a polyolefin heat-bonding fiber having heat-bonding capability, a monofilament may be used so long as it has heat-bonding capability. Particularly preferred is a sheath-core type heat-bonding composite fiber containing a polyethylene, especially, a high-density polyethylene as a low-melting component and polypropylene as a high-melting component.

The denier and the fiber length of the polyolefin staple fiber are not specially limited. In view of a filter material and a wiper to which the obtained electret non-woven fabric is mainly applied, the polyolefin staple fiber has a size of approximately 0.5 to 50.0 dTex, preferably 1.0 to 30.0 dTex and a fiber length of approximately 30 to 76?? mm.

[symbol]

The oil that is applied to the fiber in the present invention is an oil containing, as a main component, an ester obtained from a polyethylene glycol having a molecular weight of 400 to 800 and a fatty acid having 10 to 20 carbon atoms. The amount of the oil adhering to the fiber is in the range of from 0.05 to 1.0% by weight, preferably from 0.2 to 0.6% by weight. When the polyethylene glycol has a molecular weight of less than 400, the oil is less soluble in water, which may cause a problem in use. When the above molecular weight exceeds 800, the insulation resistance of the oil increases, and undesirably, there is liable to be caused a problem that electrostatic charge occurs in the step of opening and carding the fiber.

The fatty acid for the above ester preferably has 10 to 20 carbon atoms in view of the effect of the present invention. The fatty acid may be any one of a saturated fatty acid and an unsaturated fatty acid, and it may be any one of a linear fatty acid and a branched fatty acid. Examples of the above fatty acid include decanoic acid, lauric acid, myristic acid, palmitic acid, stearic acid, isostearic acid and oleic acid. Further, while the above ester may be any one of a diester and a monoester, a monoester is preferred in view of the effect of the present invention.

According to phenomena that the above oil used for the fiber of the present invention shows when heat-treated, it is assumed that its hydrophilic groups infiltrate the fiber and that its hydrophobic groups are actually present on the fiber surface. In the present invention, the oil may contain one or more esters from polyethylene glycol and fatty acid, or may additionally contain other known oil so long as the effect of the present invention is not impaired.

The amount of the oil adhering to the heat-bonding fiber or the non-woven fabric is measured by the following method.

<Measurement of Amount of Adhering Oil>

An adhering oil is extracted from 2 g of a sample in an ethyl alcohol/methyl alcohol mixture solvent having an ethyl alcohol/methyl alcohol weight ratio of 2/1 with a rapid residual-oil extractor (R-II model, supplied by Tokai Keiki K.K.), the extracted oil is measured for an amount, and the amount of the adhering oil is calculated on the basis of the following equation.

Amount of adhering oil (wt %)=[amount of extracted oil (g)/sample weight (g)]×100

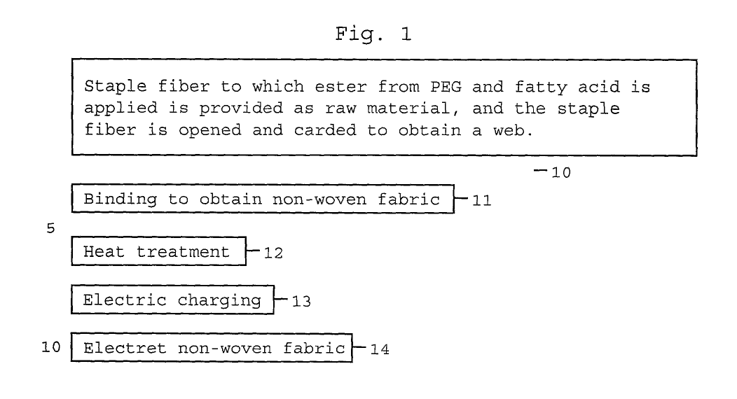

The process for the production of the electret non-woven fabric of the present invention comprises the following steps, as is shown in FIG. 1.

In a first step 10, there is provided a staple fiber to which an oil containing, as a main component, an ester obtained from a polyethylene glycol having a molecular weight of 400 to 800 and a fatty acid having 10 to 20 carbon atoms is applied. The staple fiber is opened and carded, to obtain a web.

In the first step, the above polyolefin staple fiber of the present invention may be mixed with other fiber in a proper mixing ratio as required depending upon a use for a filter material, etc., to obtain a mixture web.

In a second step 11, the web obtained in the first step is bounded, for example, needle-punched or stitch-bonded, to obtain a non-woven fabric having a proper tensile strength.

In a third step 12, the non-woven fabric obtained in the above second step is heat-treated. The heat-treatment is preferably carried out at a temperature of 102° C. to 145° C.

The above second and third steps may be carried out at the same time by hot bonding or hot press bonding.

In a fourth step 13, the non-woven fabric obtained in the above third step is electrically charged, to obtain an electret non-woven fabric 14.

The non-woven fabric 14 obtained by the above process can be used to produce a filter material or a filter device, which exhibits remarkably improved filtration efficiency. Further, a wiper can be also produced from the non-woven fabric 14.

The present invention will be explained more in detail with reference to Examples hereinafter.

Bay way of Example 1 of a fiber, a sheath-core type composite fiber was spun from a high-density polyethylene (PE) as a sheath component and polypropylene (PP) as a core component by a conventional method and then stretched. The stretched fiber was crimped to impart it with crimps at a rate of 6 crimps/cm with a stuffing box, and an oil of a monoester formed from polyethylene glycol having a molecular weight of 600 and oleic acid was applied to the fiber. The fiber was heat-treated, to give a PE/PP heat-bonding fiber having a denier of 2.2 dTex and a length of 51 mm. The heat-bonding fiber had an adhering oil amount of 0.3% by weight.

By way of Example 2 of a fiber, a PE/PP heat-bonding fiber having a denier of 2.2 dTex and a length of 51 mm and having an adhering oil amount of 0.3% by weight was obtained in the same manner as in Example 1 except that the oil was replaced with a monoester obtained from polyethylene glycol having a molecular weight of 400 and lauric acid.

By way of Comparative Example, a PE/PP heat-bonding fiber having a denier of 2.2 dTex and a length of 51 mm and having an adhering oil amount of 0.3% by weight was obtained in the same manner as in Example 1 except that the oil was replaced with potassium phosphate whose alkyl chain had 8 carbon atoms (C8 phosphate potassium salt).

Then, each of staple fibers of the PE/PP heat-bonding fibers in Examples 1 and 2 and Comparative Example is opened and carded in the first step 10, to form webs having a weight per unit area of 60 g/m².

Then, each web is bound by hot air-through bonding in the second step 11. While the binding and the heat treatment (third step 12) are carried out at the same time in these Examples, the third step 12 may be carried out after the second step 11. The “hot air-through bonding” refers to a method in which a polyethylene in a composite fiber is melted with hot air having a temperature, for example, of 138° C. to bond one fiber to another, and a non-woven fabric having a proper tensile strength can be obtained. The hot air-through bonding can be carried out at a hot-air temperature in the range of from 102° C. to 145° C.

The non-woven fabric obtained in the above third step 12 is electrically charged in the fourth step 13, to give an electret non-woven fabric 14.

Table 1 shows adhering-oil amounts of the source fibers and the non-woven fabrics formed and decrease ratios of the amounts of the adhering oils.

TABLE 1

| | | Amount | Amount | |
|---|---|---|---|---|
| | | of oil | of oil | |
| | | adhering | adhering | |
| | | to | to non- | Decrease |
| | | source | woven | ratio of |
| | | fiber | fabric | adhering |
| | Oil | (wt %) | (wt %) | oil (%) |
| Example 1 | Polyethylene | 0.3 | 0.04 | 86.7 |
| | glycol oleic | | | |
| | acid monoester | | | |
| | (PEG600) | | | |
| Example 2 | Polyethylene | 0.3 | 0.03 | 90.0 |
| | glycol lauric | | | |
| | acid monoester | | | |
| | (PEG400) | | | |
| Comparative | C8 phosphate | 0.3 | 0.28 | 6.7 |
| Example | potassium salt | | | |

The electret non-woven fabrics 14 obtained in Examples 1 and 2 can be used as a filter for general air-conditioning system. For example, they can be used as a filter net for an air-conditioner or as a filter net in an inlet or outlet of a tubing of an air-conditioning system. Further, the above electret non-woven fabric can be used as an intermediate- or low-efficient filter net or as a filter material for a bag type filter in combination with a filter material other than the electret non-woven fabric 14. According to experiments, the non-woven fabrics before the electric-charging show a filtration efficiency of only about 5%, but the non-woven fabrics that are electrically charged come to show a filtration efficiency of approximately 70%. Further, the electrically charged (or electret) non-woven fabrics still retain a differential pressure of 0.1 mm (H₂O) at a flow rate of 32 liters/minute. That is, the electret non-woven fabrics can show remarkably high filtration efficiency without changing a conventional differential pressure.

A filter material or a filter device made of the non-woven fabric 14 obtained by the above process can be improved in filtration efficiency.

According to the production process of the present invention, when non-heating binding treatment such as needle-punching or stitch-bonding is carried out as binding treatment in the second step 11, it is required to carry out the heat treatment in the above third step 12. When heating binding treatment such as hot air-through treatment or hot pressing is carried out in the second step 11, such binding treatment can also work as heat treatment in the above third step 12, so that the second step can be directly followed by the electric-charging 13 in the fourth step, and in this case, an electret non-woven fabric can be similarly obtained.

What is claimed is:

1. A staple fiber for an electret non-woven fabric, which is a polyolefin heat-bonding fiber having 0.05 to 1.0% by weight of an oil adhering thereto, characterized in that the amount of the adhering oil decreases to 0.001 to 0.2% by weight, and that the decrease ratio of the amount of the adhering oil, represented by the equation (I), can be at least 60%,
Decrease ratio (%) of the amount of the adhering oil=[(A−B)/A]×100 (I)
wherein A is an amount (% by weight) of the oil adhering to the heat-bonding fiber and B is an amount of the oil adhering to the non-woven fabric after the heat treatment,
under heat treatment for forming the polyolefin heat-bonding fiber into a non-woven fabric and/or under heat treatment of a non-woven fabric formed of the polyolefin heat-bonding fiber.

2. The staple fiber of claim 1, wherein the oil contains, as a main component, an ester obtained from polyethylene glycol having a molecular weight of 400 to 800 and a fatty acid having 10 to 20 carbon atoms.

3. The staple fiber of claim 1, wherein the polyolefin heat-bonding fiber has 0.2 to 0.6% by weight of an oil adhering thereto.

4. The staple fiber of claim 1, which is a polyolefin composite fiber.

5. The staple fiber of claim 4, wherein the polyolefin composite fiber is a sheath-core composite fiber containing polyethylene as a sheath portion.

6. A process for the production of an electret non-woven fabric, which comprises;
the first step of providing, as a raw material, a staple fiber to which an oil containing, as a main component, an ester obtained from a polyethylene glycol having a molecular weight of 400 to 800 and a fatty acid having 10 to 20 carbon atoms is applied, and opening and carding said staple fiber, to obtain a web,
the second step of binding the web to obtain a non-woven fabric,
the third step of heat-treating the non-woven fabric, and
the fourth step of electrically charging the heat-treated non-woven fabric, to obtain an electret non-woven fabric.

7. The process of claim 6, wherein a polyolefin composite fiber is used as the staple fiber in the first step.

8. The process of claim 6, wherein a sheath-core type composite fiber containing polyethylene as a sheath portion is used as the staple fiber in the first step.

9. The process of claim 6, wherein the staple fiber to which 0.2 to 0.6% by weight, based on the fiber, of the oil is applied is used in the first step.

10. The process of claim 6, wherein the web is needle-punched or stitch-bonded in the second step.

11. The process of claim 6, wherein the binding in the second step and the heat-treatment in the third step are simultaneously carried out by hot air-through bonding or hot press bonding.

12. The process of claim 6, wherein the heat treatment in the third step is carried out at a temperature of 102° C. to 145° C.

13. An article obtained from an electret non-woven fabric obtained by the process recited in any one of claims 6 to 12.

14. The article of claim 13, which is a filter material, a filter device or a wiper.
